(19) United States
(12) Patent Application Publication
(10) Pub. No.: US 2010/0310277 A1
(43) Pub. Date: Dec. 9, 2010

(54) TONER CARTRIDGE AND IMAGE FORMING APPARATUS

(75) Inventor: Tadao KAMANO, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/793,324

(22) Filed: Jun. 3, 2010

Related U.S. Application Data
(60) Provisional application No. 61/184,728, filed on Jun. 5, 2009.

(51) Int. Cl. G03G 15/08

(52) U.S. Cl. 399/263

(57) ABSTRACT

According to one embodiment, a toner cartridge includes a housing, plural paddles and an auger. The housing contains a toner and has a shape spreading in a gravity direction in a state of being supported in an image forming apparatus. The plural paddles agitate the toner in an area including a bottom surface of the housing in the gravity direction in the state of being supported in the image forming apparatus. The auger delivers the toner agitated by the plural paddles.

### CROSS REFERENCE TO RELATED APPLICATIONS

This application is based upon and claims the benefit of priority from U.S. Provisional Application No. 61/184,728 filed on Jun. 5, 2009; the entire contents of which are incorporated herein by reference.

### FIELD

Embodiments described herein relate generally to a toner cartridge and an image forming apparatus.

### BACKGROUND

In a toner cartridge used for an image forming apparatus, toner is loosened by operating a paddle. In order to agitate the toner in the whole toner cartridge, a large paddle is required. However, when the paddle in the toner cartridge is enlarged, a large driving force is required in order to operate the paddle.

### BRIEF DESCRIPTION OF THE DRAWINGS

FIG. 1 is a sectional view showing a structural example of a digital multi-functional peripheral.

FIG. 2 is a block diagram showing a structure of a control system of the digital multi-functional peripheral.

FIG. 3 is a sectional view showing a toner cartridge of a first structural example.

FIG. 4 is a perspective view of the toner cartridge of the first structural example shown in FIG. 3.

FIG. 5 is a view showing a structural example of a drive mechanism in the toner cartridge.

FIG. 6 is a sectional view showing a toner cartridge of a second structural example.

FIG. 7 is a perspective view of the toner cartridge of the second structural example shown in FIG. 6.

FIG. 8 is a sectional view of a toner cartridge of a third structural example.

FIG. 9 is a perspective view of the toner cartridge of the third structural example shown in FIG. 8.

### DETAILED DESCRIPTION

In general, according to one embodiment, a toner cartridge includes a housing, plural paddles and an auger. The housing has a shape spreading in a gravity direction in a state of being supported in an image forming apparatus and contains a toner. The plural paddles agitate toner in an area including a bottom surface of the housing in the gravity direction in the state of being supported in the image forming apparatus. The auger delivers the toner agitated by the plural paddles.

Hereinafter, an embodiment will be described in detail with reference to the drawings.

First, a structural example of a printer 1 as an image forming apparatus will be described.

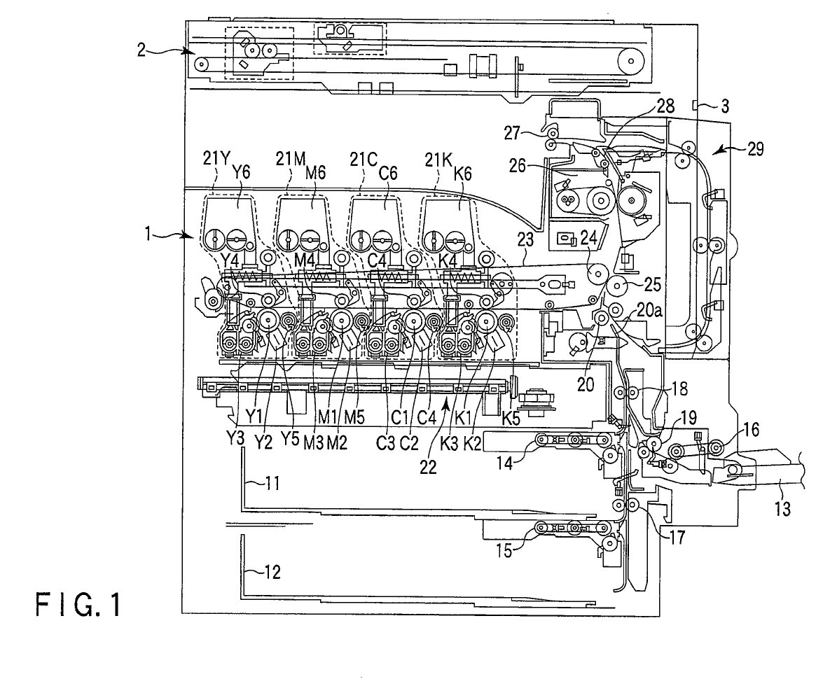

FIG. 1 is a sectional view showing a structural example of a digital multi-functional peripheral (MFP) including the printer 1 as the image forming apparatus. The digital multi-functional peripheral shown in FIG. 1 includes the printer 1, a scanner 2 and an external interface 3.

The printer 1 prints an image on a sheet as an image forming target medium. The printer 1 is an image forming apparatus of an electrophotographic system. The scanner 2 optically reads an image of a document and converts it into image data. For example, when the digital multi-functional peripheral 1 is in a copy mode, the scanner 2 reads the image of the document to be printed on a sheet by the printer 1. The external interface 3 is an interface for performing data communication with an external apparatus. For example, when the digital multi-functional peripheral 1 is in a printer mode, the external interface 3 inputs image data to be printed on a sheet by the printer 1 from the external apparatus.

Next, a structural example of the printer 1 will be described.

The printer 1 includes an upper cassette 11 for feeding a sheet on which an image is printed, a lower cassette 12 and a manual feed tray 13. The upper cassette 11, the lower cassette 12 and the manual feed tray 13 respectively include paper feed rollers 14, 15 and 16 to take out sheets one by one. The printer 1 includes a lower conveyance roller 17 for conveying the fed sheet, an upper conveyance roller 18 and a manual feed conveyance roller 19. The lower conveyance roller 17 conveys the sheet taken out by the paper feed roller 15 to the conveyance roller 18. The manual feed conveyance roller 19 conveys the sheet taken out by the paper feed roller 16 to the upper conveyance roller 18. The upper conveyance roller 18 conveys the sheet taken out by the paper feed roller 14, the sheet conveyed by the lower conveyance roller 17, or the sheet conveyed by the manual feed conveyance roller 19 to a register roller 20.

The register roller 20 conveys the sheet at a desired timing (timing when an image is transferred to the sheet). The conveyance of the sheet conveyed by the upper conveyance roller 18 is once stopped at the time point when the leading edge of the sheet reaches the register roller 20. The register roller 20 conveys the sheet, the conveyance of which is once stopped, at the desired timing. The register roller 20 rotates to convey the sheet at a constant conveyance speed. The conveyance speed of the sheet by the register roller 20 is the constant conveyance speed.

A register sensor 20a detects the sheet reaching the register roller 20 and the sheet conveyed by the register roller 20. For example, the register sensor 20a outputs an ON signal in a state of detecting the sheet, and outputs an OFF signal in a state of not detecting the sheet. When the output signal of the register sensor 20a is changed from OFF to ON, an after-mentioned control system determines that the sheet conveyed by the upper conveyance roller 18 reaches the register roller 20. When the output signal of the register sensor 20 is changed from ON to OFF, the control system detects that the conveyance of the sheet by the register roller 20 is ended.

Plural image forming sections (21Y, 21M, 21C, 21K) respectively form images of respective colors (yellow, magenta, cyan, black). The plural image forming sections (21Y, 21M, 21C, 21K) are disposed to be opposite to an exposure unit 22 and an intermediate transfer belt 23. The exposure unit 22 forms electrostatic latent images as images to be developed with the respective colors on image carriers in the respective image forming sections (21Y, 21M, 21C, 21K). The intermediate transfer belt 23 is an intermediate transfer body as a transfer target body. A drive roller 24a and a support roller 24b hold the intermediate transfer belt 23 as the transfer target body at a suitable tension. The intermediate transfer belt 23 is driven by the rotation of the drive roller 24a. The respective image forming sections (21Y, 21M, 21C, 21K) develop the electrostatic latent images with toners of the respective colors (yellow, magenta, cyan, black) and form toner images on the intermediate transfer belt 23.

The respective image forming sections 21Y, 21M, 21C and 21K respectively include photoconductive drums Y1, M1, C1 and K1, charging rollers Y2, M2, C2 and K2, developing units Y3, M3, C3 and K3, transfer rollers Y4, M4, C4 and K4, cleaners Y5, M5, C5 and K5 and toner cartridges Y6, M6, C6 and K6. The respective image forming sections 21Y, 21M, 21C and 21K can be realized by the same structure except for the toner color. Here, as an example of the image forming section, the image forming section 21Y will be described. The image forming sections 21M, 21C and 21K can be realized by the same structure as the image forming section 21Y.

The photoconductive drum Y1 is an image carrier. The photoconductive drum Y1 includes an organic or amorphous silicon photoconductive layer on a conductive substrate. For example, the photoconductive drum Y1 is an organic photoreceptor charged to a minus polarity. The charging roller Y2 uniformly charges the surface of the photoconductive drum Y1 rotated by a not-shown motor. The exposure unit 22 emits an image-modulated laser beam. The exposure unit 22 irradiates the laser beam to the photoconductive drum Y1. An exposure position where the laser beam from the exposure unit 22 is irradiated is a surface area of the photoconductive drum Y1 after being charged by the charging roller Y2. At the exposure position, the laser beam forms an electrostatic latent image on the surface of the photoconductive drum Y1.

The developing unit Y3 develops (visualizes) the electrostatic latent image formed on the surface of the photoconductive drum Y1. The developing unit Y3 develops the electrostatic latent image by a two-component developing system in which a non-magnetic toner charged to have a negative polarity and a magnetic carrier are mixed. The developing unit Y3 develops the electrostatic latent image with the yellow toner. The toner is not attached to a part of the surface of the photoconductive drum Y1 to which the laser beam is not irradiated (part not exposed), and the toner is attached to a part to which the laser beam is irradiated (part exposed). The photoconductive drum Y1 holds the toner image which appears by the attachment of the toner. Incidentally, in addition to the two-component developing system, a system such as contact one-component development, non-contact one-component development, or conductive one-component development can also be applied.

The toner image formed on the surface of the photoconductive drum Y1 is transferred to the intermediate transfer belt 23 as the transfer target body. The transfer roller Y4 as the transfer member contacts the back of the intermediate transfer belt 23 when viewed from the photoconductive drum Y1 side. The transfer roller Y4 supplies an electric field to transfer the toner image from the back of the intermediate transfer belt 23. The cleaner Y5 removes the residual toner remaining on the surface of the photoconductive drum Y1 after transfer. The cleaner Y5 is provided upstream of the charging roller Y2 in the rotation direction of the photoconductive drum Y1.

The toner cartridge Y6 supplies the toner to the developing unit Y3. The toner cartridge Y6 contains yellow toner supplied to the developing unit Y3. The toner cartridge Y6 includes plural paddles to agitate the toner. Each of the paddles in the toner cartridge Y6 is rotated by driving force of a motor which is driven and controlled by an after-mentioned drive system.

The respective image forming sections 21Y, 21M, 21C and 21K overlappingly transfer (primary transfer) toner images developed with the toners of the respective colors (yellow, magenta, cyan, black) onto the intermediate transfer belt 23. A color image in which the toner images of the respective colors are superimposed is formed on the intermediate transfer belt 23. The color image of toners of the plural colors transferred on the intermediate transfer belt 23 is transferred to the sheet at a secondary transfer position. The secondary transfer position is the position where the toner image on the intermediate transfer belt 23 is transferred to the sheet. The secondary transfer position is the position where the support roller 24 and the secondary transfer roller 25 face each other.

The register roller 20 conveys the sheet to the secondary transfer position as the image transfer position in synchronization with the toner image on the intermediate transfer belt 23. The toner image on the intermediate transfer belt 23 is transferred to the sheet at the secondary transfer position. When the support roller 24 is grounded, a bias of positive (+) polarity is applied to the secondary transfer roller 25 in order to transfer the toner to the sheet as the second transfer target body. Incidentally, a structure may be such that the secondary transfer roller 25 is grounded and the negative bias is applied to the support roller 24. The sheet on which the toner image is transferred at the secondary transfer position passes through the fixing unit 26. The fixing unit 26 fixes the toner image transferred on the sheet to the sheet.

The fixing unit 26 conveys the sheet to a paper discharge roller 27. The paper discharge roller 27 discharges the sheet to a discharge section. An inversion gate 28 is provided between the fixing unit 26 and the paper discharge roller 27. The inversion gate 28 guides the sheet conveyed from the fixing unit 26 to the paper discharge roller 27. The inversion gate 28 guides the sheet switched back from the paper discharge roller 27 to an auto duplex unit (ADU) 29. The ADU 29 includes plural conveyance rollers. The plural conveyance rollers in the ADU 29 convey the sheet switched back from the paper discharge roller 27 to the register roller 20.

Next, a structure of the control system in the digital multi-functional peripheral will be described.

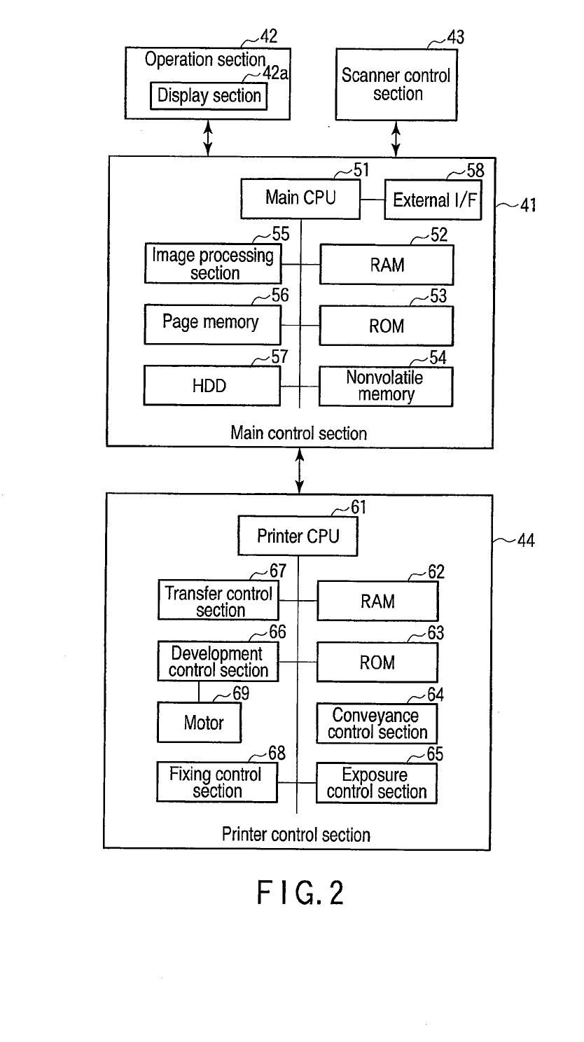

FIG. 2 is a block diagram showing the structure of the control system of the digital multi-functional peripheral including the printer 1.

As shown in FIG. 2, the control system of the digital multi-functional peripheral includes a main control section 41, an operation section 42, a scanner control section 43 and a printer control section 44.

The main control section 41 controls the entire digital multi-functional peripheral including the printer 1. The main control section 41 includes a main CPU 51, a RAM 52, a ROM 53, a nonvolatile memory 54, an image processing section 55, a page memory 56, a HDD 57 and an external interface 3.

The main CPU 51 performs control of the respective sections of the main control section 41, data processing and the like. The main CPU 51 executes control programs stored in the ROM 53, the nonvolatile memory 54, the HDD 57 or the like and realizes various processes and various functions. For example, the main CPU 51 uses a program for copying to control the scanner 2 and the printer 1 and executes copying. Besides, the main CPU 51 uses a control program for printing to control the external interface 3 and the printer 1 and executes network printing.

The RAM 52 is a memory for temporarily storing data for working and data for reference. The ROM 53 is an unrewritable nonvolatile memory. The ROM 53 stores, for example, a control program for controlling the digital multi-functional peripheral, control data and the like.

The nonvolatile memory 54 is a rewritable nonvolatile memory. The nonvolatile memory 54 is composed of an EEPROM or a flash ROM. The nonvolatile memory 54 stores system setting information. In this embodiment, the nonvolatile memory 54 stores set values of sizes of sheets to be set in the upper cassette 11, the lower cassette 12 and the manual feed tray 13 which are plural paper feed sections. Incidentally, the set values of the sheet sizes for the upper cassette 11, the lower cassette 12 and the manual feed tray 13 are values indicating at least the sheet width and sheet length in the sheet conveyance direction.

The image processing section 55 performs various image processes on the image data. The image processing section 55 performs image processes, such as image data correction, compression or expansion. For example, when a copying process is performed, the image processing section 55 performs image processes, such as shading correction, gradation correction or inter-line correction, on image data read by the scanner 2.

The page memory 56 is a memory having a storage area in which image data of at least one page is expanded. The HDD 57 is a large capacity storage device. The HDD 57 is used also as a backup memory for various data. The HDD 57 may store various setting data or management data.

The external interface 3 is an interface to perform data communication with an external apparatus. The external interface 3 is an interface to perform data communication with an external apparatus connected to a local area network (LAN) through a network cable or wireless communication.

The operation section 42 is a user interface to which an operation instruction from a user is inputted. The operation section 42 includes, for example, a hard key such as a numeric keypad, and a display section 42a having a built-in touch panel. The display section 42a of the operation section 42 displays an operation guide or a touch key (icon) selectable by the touch panel. For example, the operation section 42 detects through the touch panel that the user touches the touch key (icon) displayed on the display section 42a. Besides, the display section 42a of the operation section 42 displays, in addition to an operation guide, a guide indicating that printing can be performed, or displays a guide indicating error contents when a print error occurs.

The scanner control section 43 is a control system to control the driving of the scanner 2. That is, the scanner control section 43 controls the operation of the scanner 2 to convert an image on a document surface into image data. The scanner 2 converts the image of the document into the color or monochrome digital image data.

The printer control section 44 is a control system for the printer 1. The printer control system 44 includes a printer CPU 61, a RAM 62, a ROM 63, a conveyance control section 64, an exposure control section 65, a development control section 66, a transfer control section 67, a fixing control section 68 and a motor 69.

The printer CPU 61 controls the respective sections in the printer 1. The printer CPU 61 executes control programs stored in the ROM 63 or the like and realizes various functions. The printer CPU 61 performs a process to form an image on a sheet according to an instruction from the main control section 41. Besides, the conveyance control section 64, the exposure control section 65, the development control section 66, the transfer control section 67 and the fixing control section 68 may be functions which can be realized by control programs executed by the printer CPU 61.

The printer CPU 61 inputs detection signals of respective detectors (open and close detectors 11a and 12a, sheet detection sensors 11d, 12d and 13d, conveyance guides 11c, 12c and 13c functioning as width detectors). The printer CPU 61 notifies the main control section 41 of the detection signals of the respective detectors. However, the detection signals of the respective detectors may be directly inputted to the main CPU 51 of the main control section 41.

The RAM 62 is a memory to temporarily store data for working or to store data for reference. The ROM 63 is an unrewritable nonvolatile memory. The ROM 63 stores, for example, a control program for controlling the printer 1 and control data.

The conveyance control section 64 controls conveyance of a sheet taken out from the respective paper feed cassettes 11 and 12 and the manual feed tray 13. The conveyance control section 64 controls the operation of the paper feed rollers 14, 15 and 16, the conveyance rollers 17, 18 and 19, the register roller 20 and the like based on the operation instruction of the printer CPU 61. Besides, the conveyance control section 64 drives the respective conveyance rollers in the ADU 29, and performs conveyance control to again supply the sheet, which once passes through the fixing unit 26, to the register roller 20.

The exposure control section 65 controls the operation of the exposure unit 22. The exposure control section 65 controls the exposure unit 22 to irradiate the laser beams to the surfaces of the respective photoconductive drums Y1, M1, C1 and K1 as image carriers and forms electrostatic latent images. The development control section 66 controls the respective developing units Y3, M3, C3 and K3 to supply toners to the photoconductive drums Y1, M1, C1 and K1. That is, the development control section 66 visualizes the electrostatic latent images formed on the photoconductive drums Y1, M1, C1 and K1.

Besides, the development control section 66 replenishes toner to the respective developing units Y3, M3, C3 and K3 from the toner cartridges Y6, M6, C6 and K6. The development control section 66 drives plural rollers (after-mentioned plural paddles and an auger) provided in the respective toner cartridges Y6, M6, C6 and K6, and extracts the toner to be replenished to the respective developing units Y3, M3, C3 and K3 from the toner cartridges Y6, M6, C6 and K6. The development control section 66 controls driving of the motor 69, and controls driving of the plural rollers provided in the respective toner cartridges Y6, M6, C6 and K6.

The transfer control section 67 transfers the toner images of the respective colors formed on the respective photoconductive drums Y1, M1, C1 and K1 onto the transfer belt 23. The transfer control section 67 transfers the toner images of the respective colors formed on the transfer belt 23 to the sheet. The fixing control section 68 performs fixing control to fix the toner images transferred to the sheet by the fixing unit.

Next, a first structural example of a toner cartridge will be described.

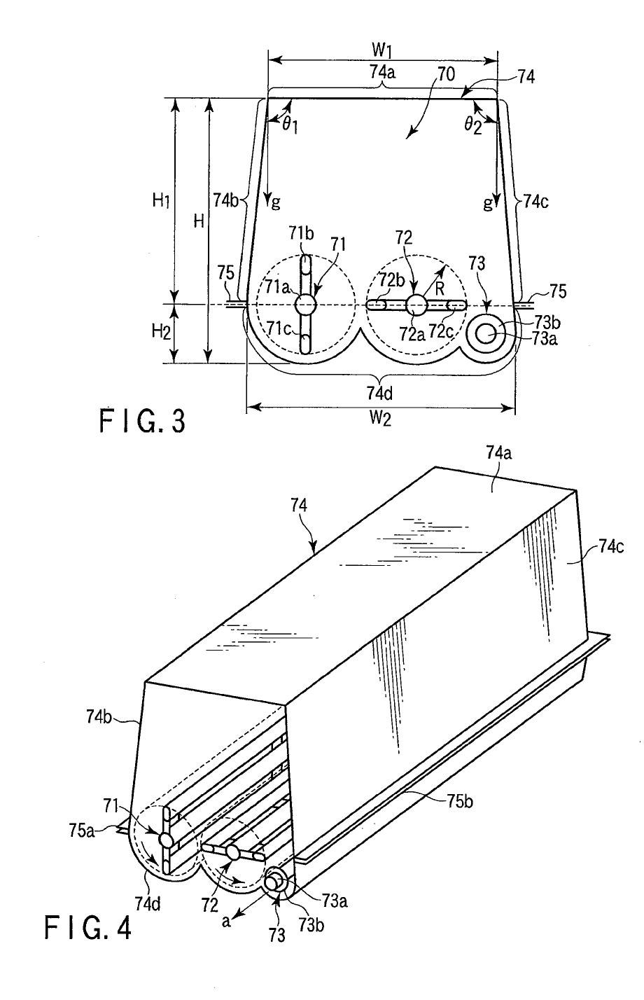

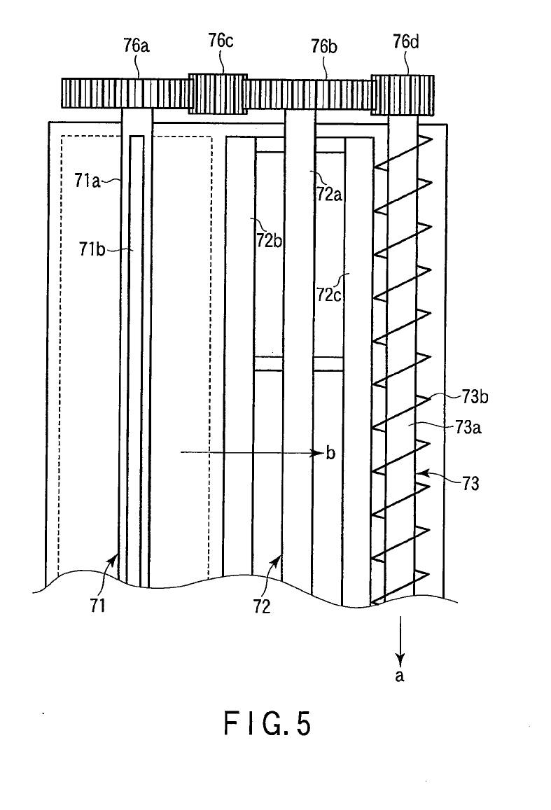

FIG. 3 is a sectional view showing the first structural example of the toner cartridge 70. The toner cartridge 70 of the first structural example shown in FIG. 3 is applicable as the toner cartridges Y6, M6, C6 and K6. FIG. 4 is a perspective view of the toner cartridge 70 of the first structural example shown in FIG. 3. FIG. 5 is a view showing a structural example of a drive mechanism in the toner cartridge 70.

As shown in FIG. 3 and FIG. 4, the toner cartridge 70 of the first structural example includes a first paddle 71, a second paddle 72, an auger 73, a housing 74 and a guide 75. The printer 1 in the digital multi-functional peripheral holds the toner cartridge 70. The guide 75 guides the toner cartridge 70. For example, the printer 1 of the structure shown in FIG. 1 holds the toner cartridge 70 containing yellow toner as the toner cartridge Y6, holds the toner cartridge 70 containing magenta toner as the toner cartridge M6, holds the toner cartridge 70 containing cyan toner as the toner cartridge C6, and holds the toner cartridge 70 containing black toner as the toner cartridge K6.

The housing 74 includes an upper surface 74a, a side surface 74b, a side surface 74c and a bottom surface 74d. The housing 74 contains toner in a space surrounded by the upper surface 74a, the side surface 74b, the side surface 74c and the bottom surface 74d. In the structural example shown in FIG. 3 and FIG. 4, in the state where the toner cartridge is set in the printer 1, the upper surface 74a is a plane directed in the direction (horizontal direction) vertical to a gravity direction g. The side surface 74b and the side surface 74c are connected to the upper surface 74a in a state where they are inclined to spread in the gravity direction. The side surfaces 74b and 74c connected to the upper surface 74a in the inclined state are connected to the bottom surface 74d at the position where the width in the horizontal direction becomes maximum.

As shown in the sectional view of FIG. 3, when the width including the contact portions of the upper surface 74a and the side surfaces 74b and 74c and extending in the horizontal direction is W1, and the width including the contact portions of the side surfaces 74b and 74c and the bottom surface 74d and extending in the horizontal direction is W2, the housing 74 is formed so that W1<W2 is established. Besides, an angle θ1 of the contact portion between the side surface 74b and the upper surface 74a and an angle θ2 of the contact portion between the side surface 74c and the upper surface 74a are larger than 90 degrees. The angle θ1 and the angle Θ2 have only to be larger than 90 degrees, and may be the same angle or may be different angles. That is, in the state where the toner cartridge is set in the printer 1, the side surfaces 74b and 74c are inclined in the gravity direction g and are connected to the upper surface 74a and the bottom surface 74d so that the space to contain toner in the housing 74 spreads downward.

The first paddle 71, the second paddle 72 and the auger 73 are provided in the space to contain the toner in the housing 74. The first paddle 71, the second paddle 72 and the auger 73 are rollers to rotate around rotation shafts 71a, 72a and 73a. The first paddle 71, the second paddle 72 and the auger 73 agitate the toner in the housing 74.

In the toner cartridge 70 of the first structural example, the first paddle 71 includes the rotation shaft 71a and two blades 71b and 71c. The first paddle 71 agitates the toner by the blades 71b and 71c rotating around the rotation shaft 71a. The first paddle 71 conveys the agitated toner to the second paddle 72.

The second paddle 72 includes the rotation shaft 72a and two blades 72b and 72c. The second paddle 72 agitates the toner by the blades 72b and 72c rotating around the rotation shaft 72a. The second paddle 72 conveys the agitated toner to the auger 73.

The auger 73 includes the rotation shaft 73a and a helical blade 73b. The auger 73 delivers the toner by the helical blade 73b rotating around the rotation shaft 73a. In the toner cartridge 70 of the first structural example, the auger 73 delivers the toner supplied from the second paddle 72 to an arrow “a” direction shown in FIG. 4 and FIG. 5.

The first paddle 71 and the second paddle 72 are placed side by side in the lower part of the housing 74. The rotation shaft 71a of the first paddle 71 and the rotation shaft 72a of the second paddle 72 are placed in the area below the middle in the up-and-down direction of the whole space to contain the toner in the housing 74 in the state where the toner cartridge is set in the printer 1. In the sectional view shown in FIG. 3, the rotation shaft 71a of the first paddle 71 and the rotation shaft 72a of the second paddle 72 are placed at a horizontal position spaced downward from the upper surface 74a by H1 while the height of the whole space to contain the toner is H. When H=H1+H2 is satisfied, H1 and H2 has a relation of H1>H2. Incidentally, H2 may be the paddle operation radius R of the first paddle 71 and the second paddle 72.

The first paddle 71 and the second paddle 72 agitate the toner deposited on the bottom surface in the housing 74. Thus, the first paddle 71 and the second paddle 72 are placed so that the toner deposited on the bottom surface of the housing 74 is in an agitatable area. That is, in the state where the toner cartridge is set in the printer 1, the first paddle 71 and the second paddle 72 agitate the entire toner deposited on the bottom surface.

Besides, in the structural example shown in FIG. 3, the width of the housing 74 is widest at the horizontal position including the rotation shaft 71a of the first paddle 71 or the rotation shaft 72a of the second paddle 72. The first paddle 71 and the second paddle 72 can agitate in the area where the width is widest in the housing 74. That is, in the structural example shown in FIG. 3, all the space from the bottom surface 74d to the horizontal position (position where the width is widest) including the rotation shaft 71a and the rotation shaft 72a becomes certainly the agitating range.

In the toner cartridge 70 of the first structural example, in the state where it is set in the printer 1, toner above the position where the width in the horizontal direction is widest falls downward by its own weight even if it is solidified since the side surface is inclined. That is, in the housing 74, the toner does not remain in the area (space above the position where the width is widest) where the first paddle or the second paddle can not agitate. As a result, in the toner cartridge 70 of the first structural example, the toner in the housing 74 can be certainly agitated by the first paddle 71 or the second paddle 72.

Next, the structure of the drive mechanism in the toner cartridge 70 of the first structural example will be described.

As shown in FIG. 5, in the toner cartridge 70 of the first structural example, a first gear 76a is fixed to the rotation shaft 71a of the first paddle 71. A second gear 76b is fixed to the rotation shaft 72a of the second paddle 72. The first gear 76a and the second gear 76b are respectively engaged with an intermediate gear 76c. The intermediate gear 76c transmits the driving force given to one of the gears 76a and 76b to the other of the gears 76b and 76a. Besides, a third gear 76d is fixed to the rotation shaft 73a of the auger 73. The third gear 76d is engaged with the second gear 76b. The third gear 76d and the second gear 76b are driven together.

In the state where the toner cartridge 70 is set in the printer 1, the drive mechanism of the toner cartridge 70 as shown in FIG. 5 is connected to the motor 69 as the drive section of the printer 1. In the printer control section 44, the development control section 66 drives the motor 69 in accordance with the drive instruction of the printer CPU 61 and drives the drive mechanism of the toner cartridge 70. The rotation shaft 71a of the first paddle 71, the rotation shaft 72a of the second paddle 72 and the rotation shaft 73a of the auger 73 are rotated by the driving force of the motor 69 transmitted through the respective gears 76a to 76d.

The first paddle 71 includes the two blades (pair of blades) 71b and 71c attached to the rotation shaft 71a at intervals of 180 degrees. The second paddle 72 adjacent to the first paddle 71 includes the two blades (pair of blades) 72b and 72c attached to the rotation shaft 72a at interval of 180 degrees. The blades 71b and 71c of the first paddle 71 and the blades 72b and 72c of the second paddle 72 can be rotated at different phases. The phase difference between the blade 71b or 71c of the first paddle 71 and the blade 72b or 72c of the second paddle 72 can be set by the combination of the first gear 76a and the second gear 76b with respect to the intermediate gear 76c.

In the example shown in FIG. 3, FIG. 4 and FIG. 5, the blades 71b and 71c of the first paddle 71 and the blades 72b and 72c of the second paddle 72 rotate at a phase difference of 90 degrees. Since the blades 71b and 71c of the first paddle 71 and the blades 72b and 72c of the second paddle 72 are rotated at the different phase, the first paddle 71 and the second paddle 72 can convey the toner efficiently to the auger 73.

Next, the driving force required for driving of the toner cartridge will be described.

Here, as the driving force required for driving of the toner cartridge, torque (paddle drive torque) required for driving all the paddles will be described. The paddle drive torque becomes a value which can be calculated by the following calculation expression according to the operation diameter (size of the blade) of the paddle and the number of paddles.

The angular speed ω of the paddle is calculated by following expression (1). Where, ω denotes the paddle angular speed, n denotes the number of times of passing of the blade, and N denotes the number of blades.

ω=2π×(n/N) (1)

In the calculation expression (1) of the angular speed of the paddle, when the number of times of passing of the blade and the number of blades are not changed, the paddle angular speed is not also changed.

The speed v of the blade is calculated by following expression (2). Where, v denotes the blade speed, R denotes the paddle operation diameter, and ω denotes the paddle angular speed.

v=R×ω (2)

According to the calculation expression (2) of the blade speed, when the paddle operation radius becomes 1/2, the speed of the blade becomes also 1/2. That is, in the toner cartridge provided with two paddles having the operation radius of R/2, the speed of the blade becomes 1/2 as compared with the toner cartridge provided with one paddle having the operation radius of R.

The resistance F applied to the blade is calculated by following expression (3). Where, F denotes the resistance applied to the blade, and c denotes a constant determined by the shape of the blade and the number of blades.

F=c×v×v (3)

According to the calculation expression (3) of the resistance applied to the blade, when the speed of the blade becomes 1/2, the resistance applied to the blade becomes 1/4. That is, in the toner cartridge provided with the two paddles having the operation radius of R/2, since the speed of the blade is 1/2 as compared with the toner cartridge provided with the one paddle having the operation radius of R, the resistance applied to the blade is 1/4.

The paddle drive torque T is calculated by following expression (4). Where, T denotes the paddle drive torque, and m denotes the number of paddles.

T=F×R×m (4)

According to the calculation expression (4) of the paddle drive torque, when the operation radius of the paddle is 1/2, the speed of the blade is 1/2, and the number of paddles is twice, the paddle drive torque becomes 1/2. That is, in the toner cartridge provided with the two paddles having the operation radius of R/2, as compared with the toner cartridge provided with the one paddle having the operation radius of R, since the speed of the blade is 1/2, the paddle drive torque becomes 1/2.

In the toner cartridge of the first structural example, the plural paddles are placed in the lower area of the toner cartridge so that the toner deposited on the bottom surface of the toner cartridge is in the agitation area, and the upper area of the toner cartridge where the paddle can not directly agitate is made to have the shape so that the toner falls into the agitation area of the paddle by its own weight even if the toner is solidified.

According to the toner cartridge of the first structural example, the driving force for driving the paddle can be decreased, and even if the toner is solidified in the toner cartridge, it can be certainly agitated by the paddle.

Next, a second structural example of a toner cartridge will be described.

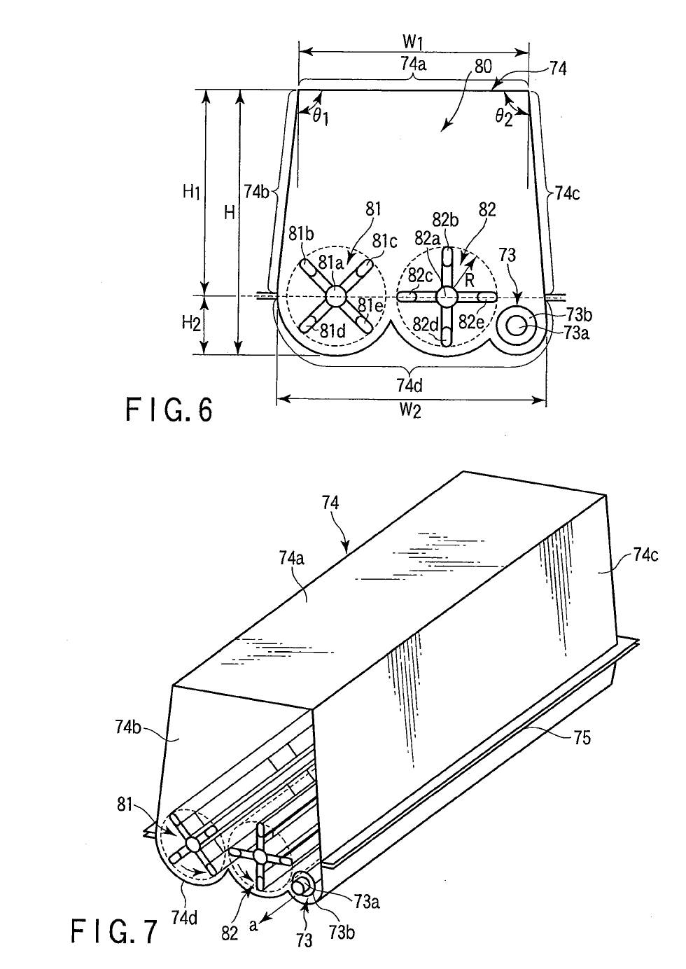

FIG. 6 is a view showing the second structural example of the toner cartridge 80. The toner cartridge 80 of the second structural example shown in FIG. 6 is applicable as the toner cartridges Y6, M6, C6 and K6. FIG. 7 is a perspective view of the toner cartridge 80 of the second structural example shown in FIG. 6.

As shown in FIG. 7 and FIG. 6, the toner cartridge 80 of the second structural example includes a first paddle 81, a second paddle 82, an auger 73, a housing 74 and a guide 75. In the toner cartridge 80 of the second structural example, the auger 73, the housing 74 and the guide 75 can be realized by those similar to those of the toner cartridge 70 of the first structural example. In the toner cartridge 80 of the second structural example, the first paddle 81 and the second paddle 82 are different in structure from the first paddle 71 and the second paddle 72 of the toner cartridge 70 of the first structural example. Incidentally, it is assumed that the agitation range (paddle operation radius) of each of the first paddle 81 and the second paddle 82 is equal to that of each of the first paddle 71 and the second paddle 72.

In the toner cartridge 80 of the second structural example, the first paddle 81 includes a rotation shaft 81a and four blades 81b, 81c, 81d and 81e. In the structural example shown in FIG. 6 and FIG. 7, the four blades 81b, 81c, 81d and 81e are attached to the rotation shaft 81a at intervals of 90 degrees. The first paddle 81 agitates the toner by the blades 81b to 81e rotating around the rotation shaft 81a. The first paddle 81 conveys the agitated toner to the second paddle 82.

In the toner cartridge 80 of the second structural example, the second paddle 82 includes a rotation shaft 82a and four blades 82b, 82c, 82d and 82e. In the structural example shown in FIG. 6 and FIG. 7, the four blades 82b, 82c, 82d and 82e are attached to the rotation shaft 82a at intervals of 90 degrees. The second paddle 82 agitates the toner by the blades 82b to 82e rotating around the rotation shaft 82a. The second paddle 82 conveys the agitated toner to the auger 73.

The first paddle 81 and the second paddle 82 in the toner cartridge 80 of the second structural example are placed side by side in the lower part of the housing 74 similarly to the first paddle 71 and the second paddle 72 of the toner cartridge of the first structural example. The rotation shaft 81a of the first paddle 81 and the rotation shaft 82a of the second paddle 82 are placed in the area below the middle in the up-and-down direction of the whole space to contain the toner in the housing 74 in the state where the toner cartridge is set in the printer 1. The first paddle 81 and the second paddle 82 agitate the toner deposited on the bottom surface in the state where the toner cartridge 80 is set in the printer 1.

Besides, as shown in FIG. 6, the agitation range of the first paddle 81 and the second paddle 82 includes all the space from the bottom surface 74d to the horizontal position (position where the width is widest) including the rotation shaft 81a and the rotation shaft 82a similarly to the first paddle 71 and the second paddle 72 of the first structural example. Accordingly, in the toner cartridge of the second structural example, similarly to the toner cartridge of the first structural example, even if the toner is solidified, the toner in the housing 74 can be certainly agitated by the first paddle 71 or the second paddle 72.

Next, a drive system of the toner cartridge of the second structural example will be described.

The toner cartridge 80 of the second structural example includes the drive mechanism similar to that of the toner cartridge 70 of the first structural example. In the toner cartridge 80 of the second structural example, the number of blades of each of the first paddle 81 and the second paddle 82 is different from that of the toner cartridge 70 of the first structural example.

When the conveyance amount of toner by one blade is the same, as the number of blades becomes large, the paddle can convey much toner even if the rotation number is small. For example, when the toner conveyance amount by one blade is the same, even if the rotation number is 1/2, the paddle having four blades can convey the same amount of toner as compared with the paddle having two blades. Besides, when the rotation number of the paddle can be reduced in the same drive system, the motor rotation number is reduced and is used in a high torque region, or the speed reduction ratio is increased and the output shaft torque can be increased.

That is, in the toner cartridge 80 of the second structural example, the number of blades is increased and the rotation number of the paddle is reduced, so that the high torque driving force can be received from the motor 69 for driving.

However, when the toner conveyance amount by each blade is decreased by increasing the number of blades, the rotation number of the paddle can not be reduced. Thus, in the toner cartridge 80 of the second structural example, in the first paddle 81 and the second paddle 82, the mutual blades are rotated at a different phase so that toner can be efficiently agitated (conveyed). In the toner cartridge 80 of the second structural example, the structure of the drive mechanism of the first paddle 81, the second paddle 82 and the auger 83 is the same as that of the toner cartridge 70 of the first structural example as shown in FIG. 5.

Each of the blades 81b to 81e of the first paddle 81 and each of the blades 82b to 82e of the second paddle 82 rotate at the different phase. The phase difference between each of the blades 81b to 81e of the first paddle 81 and each of the blades 82b to 82e of the second paddle 82 is set by the combination of the first gear 76a and the second gear 76b with respect to the intermediate gear 76c. In the example shown in FIG. 6 and FIG. 7, each of the blades 81b to 81e of the first paddle 81 and each of the blades 82b to 82e of the second paddle 82 rotate at the phase difference of 45 degrees. Each of the blades of the first paddle 81 and each of the blades of the second paddle 82 are rotated at the different phase, so that the first paddle 81 and the second paddle 82 efficiently agitate the toner and convey it to the auger 73.

In the toner cartridge of the second structural example, the plural paddles each having the plural blades are placed side by side in the lower area of the toner cartridge so that the toner deposited on the bottom surface is in the agitation area, and the upper area of the toner cartridge where the plural paddles can not directly agitate is made to have the shape so that even if the toner is solidified, it falls into the agitation area of the paddle by its own weight.

According to the toner cartridge of the second structural example, the toner conveyance amount is secured by the plural blades, and the paddle can be rotated at such a low rotation speed that the motor has high torque. As a result, in the toner cartridge of the second structural example, the number of blades can be set according to the torque characteristic of the motor.

Next, a third structural example of a toner cartridge will be described.

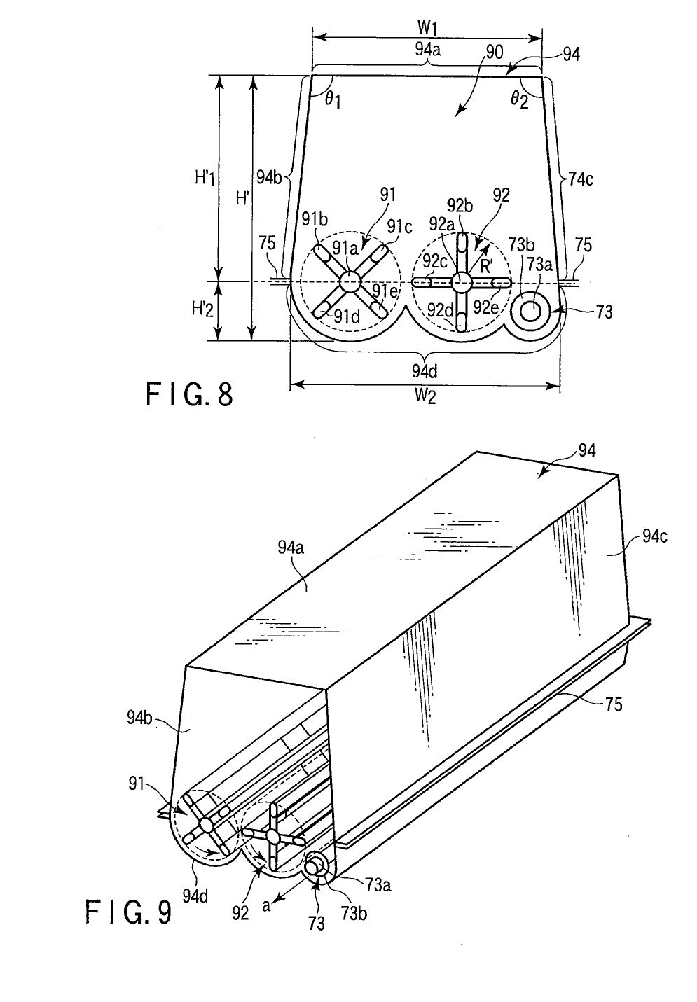

FIG. 8 is a view showing the third structural example of the toner cartridge 90. The third structural example of the toner cartridge 90 shown in FIG. 8 is applicable as the toner cartridges Y6, M6, C6 and K6. FIG. 9 is a perspective view of the toner cartridge 90 of the third structural example shown in FIG. 8.

As shown in FIG. 8 and FIG. 9, the toner cartridge 90 of the third structural example includes a first paddle 91, a second paddle 92, an auger 73, a housing 94 and a guide 75. In the toner cartridge 90 of the third structural example, the auger 73 and the guide 75 can be realized by those similar to those of the toner cartridge 70 of the first structural example. In the toner cartridge 90 of the third structural example, the first paddle 91, the second paddle 92 and the housing 94 are different in structure from those of the toner cartridge 70 of the first structural example and those of the toner cartridge 80 of the second structural example.

In the first paddle 91 and the second paddle 92 of the toner cartridge 90 of the third structural example, the number of blades is equal to that of the first paddle 81 and the second paddle 82 of the second structural example. In the toner cartridge 90 of the third structural example, four blades 91b, 91c, 91d and 91e of the first paddle 91 are attached to a rotation shaft 91a at intervals of 90 degrees. Four blades 92b, 92c, 92d and 92e of the second paddle 92 are attached to a rotation shaft 92a at intervals of 90 degrees.

The first paddle 91 and the second paddle 92 of the toner cartridge 90 of the third structural example are placed side by side in the lower part of the housing 74. The rotation shaft 91a of the first paddle 91 and the rotation shaft 92a of the second paddle 92 are placed in the area below the middle in the up-and-down direction of the whole space to contain the toner in the housing 94 in the state where the toner cartridge is set in the printer 1. The first paddle 91 and the second paddle 92 agitate the toner deposited on a bottom surface 94d in the state where the toner cartridge 90 is set in the printer 1. The bottom surface 94d of the housing 94 is made to have a shape corresponding to the agitation range of the first paddle 91 and the agitation range of the second paddle 92.

In the third structural example shown in FIG. 8, the width in the horizontal direction including the rotation shaft 91a of the first paddle 91 and the rotation shaft 92a of the second paddle 92 is made W2. However, a paddle operation radius R′ of the first paddle 91 and the second paddle 92 of the toner cartridge 90 is larger than the paddle radius R of the first paddle 81 and the second paddle 82 of the toner cartridge 80. Thus, the agitation range of the first paddle 91 and the agitation range of the second paddle 92 partially overlap with each other.

In the sectional view shown in FIG. 8, the rotation shaft 91a of the first paddle 91 and the rotation shaft 92a of the second paddle 92 are placed at the horizontal position spaced downward from an upper surface 94a by H1′ while the height of all the space containing toner is H. When H=H1′+H2′ is satisfied, H1′ and H2′ has a relation of H1′>H2′. Incidentally, H2′ may be the paddle operation radius R′ of the first paddle 91 and the second paddle 92.

Next, a drive system of the toner cartridge of the third structural example will be described.

The toner cartridge 90 of the third structural example includes the same drive mechanism as that of the toner cartridge 80 of the second structural example. However, in the toner cartridge 90 of the third structural example, since the operation radiuses (agitation ranges) of the first paddle 91 and the second paddle 92 overlap with each other, it is necessary to rotate at different phases so that the mutual blades do not collide with each other. For example, the respective blades 91b to 91e of the first paddle 91 and the respective blades 92b to 92e of the second paddle 92 rotate at a phase difference of 45 degrees. In the first paddle 91 and the second paddle 92, since the respective blades rotate at different phases, they do not collide with each other, and can efficiently agitate the toner and convey it to the auger 73.

In the toner cartridge 90 of the third structural example, the size of the blade in the first paddle 91 and the second paddle 92 is larger than that of the toner cartridge 80 of the second structural example. When the blade is large, the toner conveyance amount per one blade becomes large. When the toner conveyance amount per one blade is large, the paddle can convey much toner even if the rotation number is small. That is, the rotation number of the paddle can be reduced by the increase in the toner conveyance amount per one blade. When the rotation number of the paddle can be reduced in the same drive system, the motor rotation number is reduced and is used in a high torque region, or the speed reduction ratio is increased and the output shaft torque can be increased.

In the toner cartridge of the third structural example, the toner stored on the bottom surface is in the agitation area, the plural paddles driven so that the mutual blades do not collide with each other are placed side by side in the lower area of the toner cartridge, and the upper area of the toner cartridge where the paddle can not directly agitate is made to have the shape so that even if the toner is solidified, it falls into the agitation area by its own weight.

According to the toner cartridge of the third structural example, the blade is enlarged and the toner conveyance amount is increased, so that the rotation number of each paddle can be reduced, and the driving force of high torque in the low rotation region can be received from the motor 69 for driving. As a result, in the toner cartridge of the third structural example, the size of the blade can be set according to the torque characteristic of the motor.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A toner cartridge supported in an image forming apparatus, comprising:
a housing configured to contain a toner and have a shape spreading in a gravity direction in a state where the toner cartridge is supported in the image forming apparatus;
a plurality of paddles configured to agitate the toner in an area including a bottom surface of the housing in the gravity direction in the state where the toner cartridge is supported in the image forming apparatus; and
an auger configured to deliver the toner agitated by the plurality of paddles.

2. The toner cartridge of claim 1, wherein the housing includes a side surface inclined to spread downward with respect to an upper surface in the gravity direction.

3. The toner cartridge of claim 1, wherein the housing includes the bottom surface having a shape along orbits of the plurality of paddles.

4. The toner cartridge of claim 1, wherein each of the plurality of paddles is a roller having a rotation shaft provided with a blade to agitate the toner.

5. The toner cartridge of claim 4, wherein the respective rotation shafts of the plurality of paddles are arranged right and left in the housing in the supported state.

6. The toner cartridge of claim 5, wherein a width, in a right and left direction, of an agitation range of the plurality of paddles arranged right and left is larger than a width, in the right and left direction, of an upper surface.

7. The toner cartridge of claim 4, wherein the plurality of paddles rotate to convey the toner deposited on the bottom surface to the auger.

8. The toner cartridge of claim 4, wherein in the plurality of paddles, the plurality of blades rotate at different phases.

9. The toner cartridge of claim 8, wherein in the plurality of paddles, agitation ranges of the mutual blades partially overlap with each other and the respective blades rotate at different phases to prevent collision.

10. An image forming apparatus, comprising:
an image forming section configured to form an electrostatic latent image on an image carrier;
a developing unit configured to develop the electrostatic latent image formed by the image forming section with a toner;
a housing configured to contain the toner and have a shape spreading in a gravity direction;
a plurality of paddles configured to agitate the toner in an area of the housing including a bottom surface in the gravity direction; and
an auger configured to deliver the toner agitated by the plurality of paddles to the developing unit.

11. The apparatus of claim 10, wherein the housing includes a side surface inclined to spread downward with respect to an upper surface in the gravity direction.

12. The apparatus of claim 10, wherein the housing includes the bottom surface having a shape along orbits of the plurality of paddles.

13. The apparatus of claim 10, wherein each of the plurality of paddles is a roller having a rotation shaft provided with a blade to agitate the toner.

14. The apparatus of claim 13, wherein the respective rotation shafts of the plurality of paddles are arranged right and left in the housing in a supported state.

15. The apparatus of claim 14, wherein a width, in a right and left direction, of an agitation range of the plurality of paddles arranged right and left is larger than a width, in the right and left direction, of an upper surface.

16. The apparatus of claim 13, wherein the plurality of paddles rotate to convey the toner deposited on the bottom surface to the auger.

17. The apparatus of claim 13, wherein in the plurality of paddles, the plurality of blades rotate at different phases.

18. The apparatus of claim 17, wherein in the plurality of paddles, agitation ranges of the mutual blades partially overlap with each other and the respective blades rotate at different phases to prevent collision.

19. A toner conveying method used for image formation, comprising:
containing a toner in a housing having a shape spreading in a gravity direction in a state of being supported in an image forming apparatus;
agitating the toner in an area including a bottom surface of the housing in the gravity direction by a plurality of paddles in the state of being supported by the image forming apparatus; and
delivering the toner agitated by the plurality of paddles.

20. The method of claim 19, further comprising:
forming an electrostatic latent image on an image carrier;
developing the electrostatic latent image with the toner; and
delivering the toner agitated by the plurality of paddles to develop the electrostatic latent image.
